(19) United States
(12) Patent Application Publication
(10) Pub. No.: US 2015/0370898 A1
(43) Pub. Date: Dec. 24, 2015

(54) TEXT AND GRAPHIC BASED SEARCH QUERRY FORMULATION

(71) Applicant: THOMSON LICENSING, Issy de Moulineaux (FR)

(72) Inventors: Samir M. Ahmed, Culver City, CA (US); Patrick Sean Gildea, La Canada, CA (US); Paneeth Kongara, Los Angeles, CA (US); Shirkesh Karunakaran, Los Angeles, CA (US); Lee D. Shartzer, Valencia, CA (US); Craig Takata, Pasadena, CA (US)

(21) Appl. No.: 14/743,160

(22) Filed: Jun. 18, 2015

Related U.S. Application Data
(60) Provisional application No. 62/015,640, filed on Jun. 23, 2014.

(51) Int. Cl. G06F 17/30; G06F 3/0481; G06F 3/0484; H04L 29/08

(52) U.S. Cl. CPC G06F 17/30864; G06F 17/30914; H04L 67/306; G06F 3/04817; G06F 3/04842; G06F 17/30663; G06F 17/30038

(57) ABSTRACT

A method of generating a display of media items includes selecting a set of icons and text items representing a set of search elements. The search elements are selected and arranged by a user on a display of the user interface. A query mapper translates the set of search elements into a set of keywords and initially weights the keywords. The keywords are scaled based on information obtained from a user preference database. A weighted query using the set of keywords and the weightings for the keywords is constructed in the query mapper and sent to a search engine. An ordered list of recommendations is provided to the user for selection of an item to playback.

### FIELD

The present invention relates to user interfaces, and in particular, is related to a scheme for improving a search query by using both text and graphics.

### BACKGROUND

In systems that present media selections to a user such as audio, video, games, books, movies, and the like, the selection of a particular media item for presentation to the user is often awkward. User interfaces for searching media assets are currently limited to the entry of text by the user or worse; the selection of individual letters that form part of the title of a media asset. Such interfaces are irritating to the user because of their slow and restricted style of query generation. An easier method of generating a search query is sought that makes it easier to construct a query tailored to a user's interest.

### SUMMARY

This summary is provided to introduce a selection of concepts in a simplified form as a prelude to the more detailed description that is presented later. The summary is not intended to identify key or essential features of the invention, nor is it intended to delineate the scope of the claimed subject matter.

The present arrangement is a unique recommendation/search paradigm that allows users to fully interact with the underlying search and recommendation engine and lets a user conduct a hybrid text and graphics search. In one aspect of the invention, a method of generating a display of media items includes selecting a set of icons and text items representing a set of search elements. The search elements are constructed and arranged by the user on a user interface. A query mapper receives the search elements and translates the set of search elements into a set of keywords. An initial weighting of the keywords is determined based on the position of the translated search element in the string of search elements. A user preference is accessed which may be used to scale the initial weightings to determine a final weighting for the keywords. The weighted keywords are then sent to a search engine as a query to find media items to recommend to the user. The list of recommended media items is ordered based on the position of the search elements that produced the weighted keywords. The ordered list is presented to the user.

Additional features and advantages of the invention will be made apparent from the following detailed description of illustrative embodiments which proceeds with reference to the accompanying figures. It should be understood that the drawings are for purposes of illustrating the concepts of the disclosure and is not necessarily the only possible configuration for illustrating the disclosure.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention. In the drawings, like numbers represent similar elements.

FIG. 1 illustrates an example system block diagram and environment in which the current invention may reside;

FIG. 2 illustrates a user interface example embodiment corresponding to the current invention;

FIG. 3 illustrates an example component block diagram embodiment of the current invention;

FIG. 4; depicts an example flow diagram of the current invention; and

FIG. 5 illustrates an example media device block diagram containing aspects of the current invention.

### DETAILED DISCUSSION OF THE EMBODIMENTS

In the following description of various illustrative embodiments, reference is made to the accompanying drawings, which form a part thereof, and in which is shown, by way of illustration, how various embodiments in the invention may be practiced. It is to be understood that other embodiments may be utilized and structural and functional modification may be made without departing from the scope of the present invention.

Instead of providing a search engine that relies on textual input, the present invention provides a user interface that incorporates both textual and graphics. Most recommendations take implicit and explicit user actions and calculate behind the scenes the actual recommendations or takes specific keywords typed in by the user to perform a search. The implementation of the illustrative principles can be implemented with a search engine and a database that references media assets with different metadata.

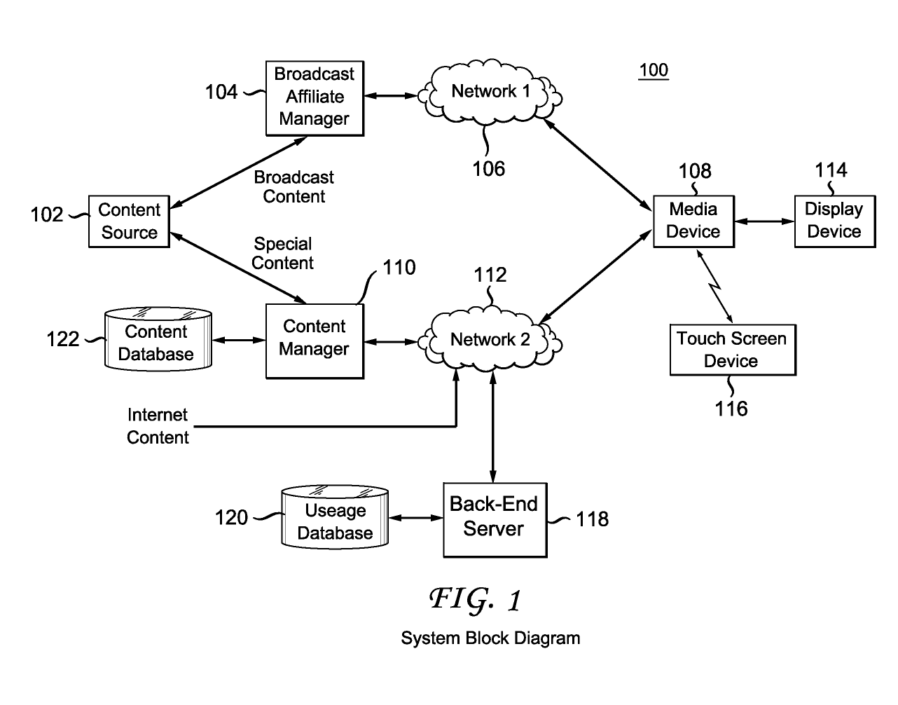

FIG. 1 is a block diagram of an embodiment of a system 100 for delivering content to a home or end user. The content originates from a content source 102, such as a movie studio or production house. The content can be supplied in at least one of two forms.

One form can be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager can collect and store the content, and can schedule delivery of the content over a delivery network, shown as delivery network 1 (106). Delivery network 1 (106) can include satellite link transmission from a national center to one or more regional or local centers. Delivery network 1 (106) can also include local content delivery using local delivery systems such as over the air broadcast, satellite broadcast, or cable broadcast. The locally delivered content is provided to a media device 108 in a user's home, where the content will subsequently be searched by the user. It is to be appreciated that the media device 108 can take many forms and can be embodied as a set top box, digital video recorder (DVR), a gateway, a modem, or any combination thereof etc. Further, the media device 108 can act as entry point, or gateway, for a home network system that includes additional devices configured as either client or peer devices in the home network.

A second form of content from content source 102 may be referred to as special content. Special content can include content delivered as premium viewing, pay-per-view, or other content otherwise not provided to the broadcast affiliate manager 104, e.g., movies, video games or other video elements. In many cases, the special content can be content requested by the user. The special content can be delivered to a content manager 110. The content manager 110 can be a service provider, such as an Internet website, affiliated, for instance, with a content provider, broadcast service, or delivery network service. The content manager 110 can also incorporate Internet content into the delivery system. The content manager 110 can deliver the content to the user's media device 108 over a separate delivery network, delivery network 2 (112). Delivery network 2 (112) can include high-speed broadband Internet type communications systems. It is important to note that the content from the broadcast affiliate manager 104 can also be delivered using all or parts of delivery network 2 (112) and content from the content manager 110 can be delivered using all or parts of delivery network 1 (106) (interconnections not shown in FIG. 1). In addition, the user can also obtain content directly from the Internet via delivery network 2 (112) without necessarily having the content managed by the content manager 110. The content manager has access to a content database 122 which serves as a repository, if not simply an access point, for content available for viewing by media device 108.

Several adaptations for utilizing the separately delivered content can be possible. In one possible approach, the special content is provided as an augmentation to the broadcast content, providing alternative displays, purchase and merchandising options, enhancement material, etc. In another embodiment, the special content can completely replace some programming content provided as broadcast content. Finally, the special content can be completely separate from the broadcast content, and can simply be a media alternative that the user can choose to utilize. For instance, the special content can be a library of movies that are not yet available as broadcast content.

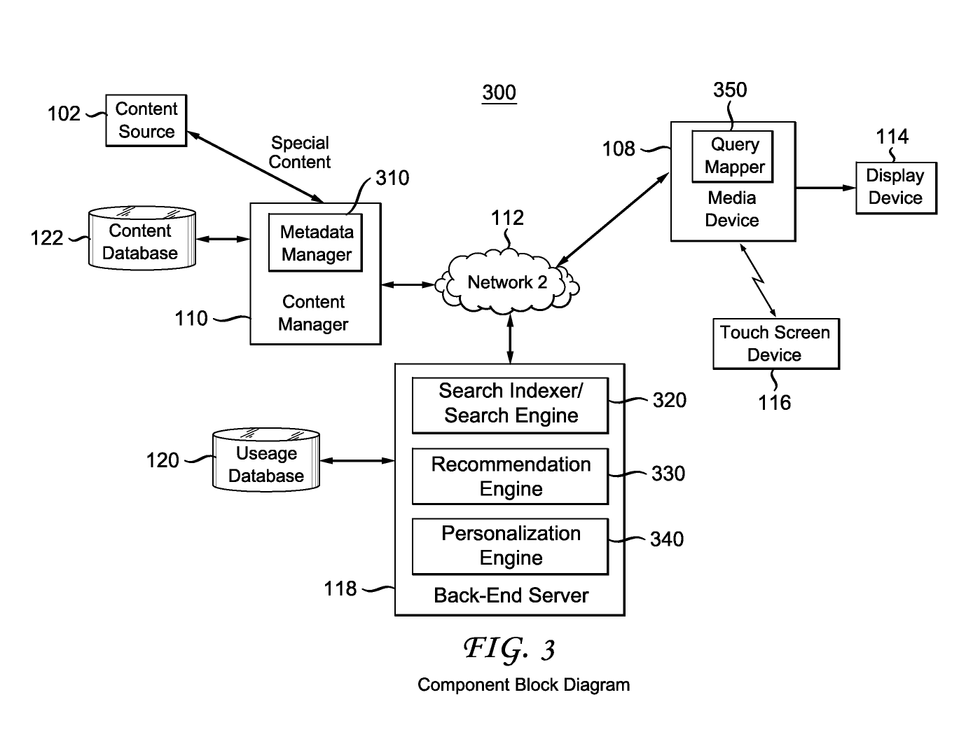

The media device 108 can receive different types of content from one or both of delivery network 1 and delivery network 2. The media device 108 processes the content, and provides such content based on user preferences and commands. The media device 108 can also include a storage device, such as a hard drive or optical disk drive, for recording and playing back audio and video content. Further details of the operation of the media device 108 and features associated with playing back stored content will be described below in relation to FIG. 3. The processed content is provided to a display device 114. The display device 114 can be a conventional 2-D type display or can alternatively be an advanced 3-D display. The display device can be a full Television device, a monitor, or a display built in and associated with the media device or gateway that contains the media device.

The media device 108 can also be interfaced to a second screen such as a touch screen control device 116. The touch screen control device 116 can be adapted to provide user control for the media device 108 and/or the display device 114. The touch screen device 116 can also be capable of displaying video and audio content. An example touch screen device can be a remote control, a digital tablet, a cell phone, a personal digital assistant, a personal computer, and the like. The video content displayed on the touch screen device 116 can be a representation of graphics or text entries, such as user interface entries (as discussed below), or can be all or a portion of the video and audio content that is delivered to the display device 114. The touch screen control device 116 can interface to media device 108 using any well known signal transmission system, such as infra-red (IR) or radio frequency (RF) communications and can include standard protocols such as infra-red data association (IRDA) standard, Wi-Fi, Bluetooth and the like, or any other proprietary protocols. Operations of touch screen control device 116 will be described in further detail below.

In the example of FIG. 1, system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 can be part of the back end server 118. In the present example, the back end server 118 (as well as the usage database 120) is connected to the system 100 and accessed through the delivery network 2 (112). In an alternate embodiment, the usage database 120 and backend server 118 can be embodied in the media device 108. In a further alternate embodiment, the usage database 120 and back end server 118 can be embodied on a local area network to which the media device 108 is connected.

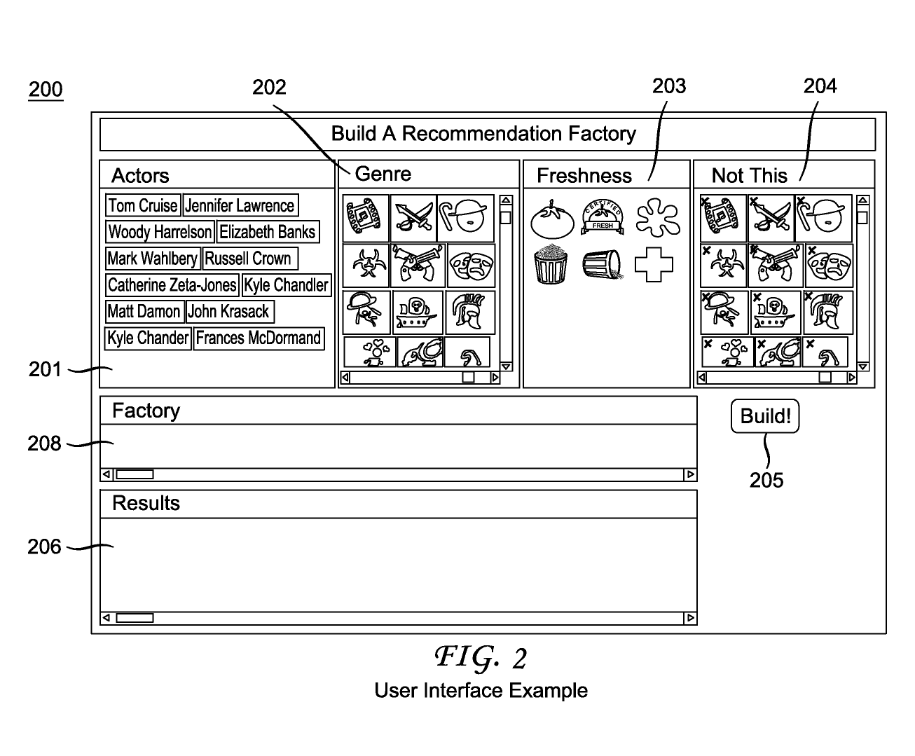

FIG. 2 illustrates one example embodiment of a user interface having aspects of the invention. Instead of providing a search engine that relies merely on textual input, the present invention provides a user interface that incorporates both textual and graphics inputs. Most prior art recommendations take implicit and explicit user actions and calculate behind the scenes the actual recommendations or take specific keywords typed in by the user to perform a search. FIG. 2 illustrates how user can input both text and graphics in an intuitive manner to perform a search. In the example of FIG. 2 the user interface 200 can include an area, such as a graphics window, that allows a user to construct an input that describes her criteria for a search. The window 208 labeled “factory” serves as an area where the user would type and enter graphics to build a desired query.

Using the interface 200 of FIG. 2, the user can select pre-existing textual words and symbols that represent search items and drag and drop them into the factory window to construct a search. Window area 201 contains pre-existing text words. In the specific embodiment of interface 200, the words are representative of actors' names. However, other text terms could be used. If the user wanted to select a name, such as “Russell Crowe”, the user would simple direct her cursor or other pointing device to drag and drop the words “Russell Crowe” from window 201 to the factory window 208. If a touch screen device were used, then the users finger would be used to perform a drag and drop of the textual words. As an alternative, the user could also select the desired words with a cursor or finger and the selected words would be entered into the factory field 208. In another alternative, the user could use a keyboard or other typing tool to type in a name or other text into the window 208. This method could be used for any text including actors' names that do not already appear in text window 201.

Window 202 is a “genre” symbol window that offers the user a list of genre-based or related icons that can be selected. The symbols that are indicated in the genre window 202 can be any genre or sub-genre category or related category or sub-category of interest. For example, symbols or icons may be provided for basic genres such as comedy and drama, and other separate symbols or icons may be provided for war movies having subcategories of WWI, civil war, ancient wars, pirate battles, etc. Icons can be used to indicate a combination of categories as well. One example is an icon for a romantic comedy. A user may select one or more of the icons in the genre window 202 by any selection means (drag and drop, clicking, etc.) in order to place the selected icon in the factory window 208 to assist in constructing her query. For example, a picture of a monster would comport to a “horror” genre, a smiling mask would relate to a “comedy” genre, while a sad mask would comport to a “drama” genre. These graphical elements can also be dragged and dropped into the “factory” area.

Another window to assist the user in graphically building a query on factory window 208 is “freshness” window 203. This window contains icons which indicate the desirability or “freshness” of the media article or media item as rated in the marketplace. Here, the example of a movie as a media item is used for convenience. The freshness window 203 may be used by a user to assist in specifying titles that are trending or recent. For example, “fresh”, desirable, and highly rated movies, (as rated by a community of viewers), may be indicated by a ripe tomato icon, a “certified fresh” sticker icon, or a full popcorn container icon. Movies that are average in desirability or rating may be indicated by a spilled popcorn icon. Movies that are low in desirability or community rating may be indicated by a “splat” icon, or a medical blue cross icon. Use of the specific icons depicted in FIG. 2 window 203 is by way of example only because other freshness icons can be used. A user may select one of the icons in the freshness window 203 by any selection means (drag and drop, clicking, etc.) in order to place the selected icon in the factory window 208 to assist in constructing her query. Use of the freshness window 203 icons can also assist in ordering a list. For example if many search result titles are found in response to a query, then the freshness icon can sort the list according to popularity by placing highly rated movies first if a ripe tomato icon is used or by listing average movies first by using a spilled popcorn icon, etc. Thus, in one aspect of the invention, the result titles may be sorted to form a list commensurate with the search elements used in the string of search elements.

Another window to assist the user in graphically building a query in the factory window 208 is the “not this” window 204. This window allows a user to select a graphic indicating a restrictive search term. For example, an icon can be selected which causes a “not” term to be added to the constructed query in factory window 208. For example, if a drama mask is selected from the “not this” area and such a term is entered into the factory window 208, then the resulting search query will use the term “Genre=Not Horror” when a search is actually conducted. May icons representing restrictive search terms may be selected in “not this” window 204.

After the user has placed all of the search elements into the factory window 208, then the user may activate the “build” button to activate processing of a search for media items. The result of a conducted search is displayed in results window 206. Typically, the results may be a simple ordered list. In an alternate format, the results window 206 may display icons or hyperlinks and the like to select a media asset. It should be noted that the user interface 200 can be used to search for any media asset that is searchable. For example, the media assets can be movies, TV shows, public videos such as You Tube™, music and other types of audio recordings, games, books, magazines, and any other form of audio or video files. Embodiments discussed herein as movies are only one type a media asset that can be searched using the principles of the invention. The searching of movies merely acts as an available example to expose the principles of the invention.

One feature of the construction of a query in the factory 208 window is the ability of a user to order the search elements (text and icons) to affect the importance and resulting weight applied to search terms. Not only is the user able to layer criteria into the search/recommendation but there is also the ability for the user to exclude specific criteria using a blacklist. Text terms and graphic icons from any of the four example element selection windows (201, 202, 203, 204) may be used in any order that the user wishes. In one embodiment, the most important terms may be placed at the beginning (left most portion) of the constructed search elements. For example, if the user wishes overall to search for a comedy, she may place the comedy icon first in the string of text and icons that she enters into factory window 208. The exception to the weighting is the “not this” element. Generally, the “not this” element may be applied equally to all terms in the element string entered into factory window 208 even though other elements may be weighted differently. One example set or string of search elements that a user may enter is:

Tomato icon, drama icon, “Matt Damon” text, “automobiles” text, not spy icon.

In the above string, the user is looking for a highly rated drama that includes actor Matt Damon and automobiles, but does not involve a spy movie. A Boolean connector of AND is assumed between the search elements. However, any other Boolean operator such as OR and NOT may also be explicitly used. The string of search elements shown above weights more heavily currently popular drama genres. Less weighted are the elements of Matt Damon and automobiles. However, the not spy icon applies equally to the entire sting of elements. So, whatever recommendation is made, it will not include a spy based genre. Any recommendation will include dramas and will most likely include dramas that include actor Matt Damon. If there are automobiles in the Matt Damon drama, those recommended movie titles will be listed first. However, if there are no dramas with Matt Damon as an actor that involve automobiles, then no automobile dramas will be listed. Likewise, if there are no dramas that include Matt Damon, but there are dramas that involve automobiles, then dramas that are not spy related that do include automobiles may be shown as recommendations. In general, if a search element listed by a user is not available, then as many search elements are used as possible to recommend a movie to a user.

After a user enters search elements into the factory window 208, the search elements are translated into text terms for the search query using a query mapper. For example, if search elements includes:

Monster icon, “Tom Cruise” text, “Matt Damon” text
Then, a look up table is accessed which indicates that the monster icon represents “horror”. The term “horror” would then be used in the resulting search query. Using the above search elements, the search query would include a query for a horror genre AND actor Tom Cruise AND actor Matt Damon. Other examples of the text terms and fields can be used in accordance with the described principles. A listing of media item or article titles matching the icon search elements is displayed to the user in the results window 206. The list of media article title results may be ordered according to the weight placed on the icons with respect to their ordering (placement) from left to right in the factory window 208. Thus, the displayed list is commensurate with the search element position.

Turning now to FIG. 3, a closer look at the component elements 300 of the lower half of FIG. 1 is provided. Here, the example distribution network 2 (112) is depicted along with interconnected functional components. As in FIG. 1, a content source 102 delivers special content, such as movies, film clips, short videos, games, and the like to a content manager 110. Such special content may be made available to the content manager 110 via a content database 122. Content requested by the media device 108 can be delivered to the media device 108 via network 2 (112).

The content source 102 can provide information about the content from the content owners. For example, if the media article provided by the content owner is a movie, a synopsis of the movie is provided. This synopsis information forms a part of data associated with the media article and is part of the metadata concerning the media article. This and other metadata are received by the content source 102 and are processed by the metadata manager 310 residing in the content manager 110. The metadata manager analyzes the metadata concerning the media item or media article, such as a movie, video, audio file, book, or other digital asset and associates the metadata with the media article. The metadata may contain a title, production date, authors, actors, production studio, genre, description, search keywords, and the like. The metadata manager 310 captures the metadata, sorts it, and associates the metadata with the media article that is made available via the content database 122. The content database contains the media article and may also contain the related metadata. The content database is loaded/maintained/updated via a communication from the content owners via the content source 102.

A search indexer and search engine 320 is part of the back-end server 118. The search indexer uses the metadata from the metadata manager 310 and provides a searchable organization of the metadata. Such an organization of metadata can be called indexing. The metadata indexing is useful by a search engine 320 to implement searches based on metadata. Thus, if keywords are one form of metadata that are organized by the metadata manager 320, then the search engine 320 can access a reference to the digital content that contains the respective keywords. As such, the search indexer and search engine work closely with each other. One of skill in the art will appreciated that these two items can be collocated into a single structure or can be separate structures that are closely bound. Each can have its own processor, memory, software instructions and input/output structure, or both functions can share the same resources.

The recommendation engine 330 of FIG. 3 is used in conjunction with the personalization engine 340 to provide recommendations in response to a user query based on information about the user in the usage database 120. The usage database 120 contains information about the user's habits, preferences, and viewings of media articles. When a query is submitted to the back end server 118 from the query mapper 350 of the media device 108, the personalization engine 340 and recommendation engine 330 functions to address user specific information that is relevant to the search. Query results can thus be generated based on the users experience and preferences with respect to the media articles. A submitted query may first be addressed by the recommendation engine 330 in conjunction with the search indexer/search engine 320. Normally, a plurality of results would be found. However, in a circumstance where there are no results from the search, then the query may be addressed by performing a more personalized search based on information from the personalization engine 340.

According to an aspect of the invention, a user entering query information into either display device 114 or touch screen device 116 interacts with a query mapper 350. In the depicted embodiment, the query mapper is located in the media device. In an alternative embodiment, the query mapper may be provisioned as part of the back end server 118. However, the query mapper 350 location of the media device 108 will be discussed as a favored example herein. However, it will be well understood by those of skill in the art that either the media device 108 location or the back-end server 118 location for the query mapper will work well. At the media device location, the query mapper 350 receives text and/or graphics element string inputs from the factory area 208 and translates the input into ordered keywords needed to form a query.

The query mapper 350 of FIG. 3 then requests personalization information with respect to the ordered keywords from the personalization engine 340 of the back-end server 118. In one embodiment, the query mapper may already have relevant personalization information in local memory of the media device 108. In that instance, the local personalization information may be used. However, for a novel query, access to the personalization engine 340 of the back-end server 118 would normally occur.

The personalization engine 340 provides user-related preferences to the query mapper 350 based on keywords presented to the personalization engine 340. The usage database 120 may be accessed to provide the personalization engine 340 with information regarding the user preferences, such as favorite subject matter, genre, age appropriateness, and the like. For example, if the query mapper 350 provided a keyword of an actor name, the combination of usage database and personalization engine would provide the query mapper 350 with information as to the user's preferences with respect to the selected actor in various genres that the user may find of interest. This information is sent back to the query mapper 350 from the personalization engine 340 to inform the query mapper 350 of ways to modify the query before submittal to the recommendation engine 330. Once the personalization engine 340 provides user preferences with respect to keywords, then the query mapper 350 can construct a final query using not only the text and graphics elements inputs by the user in factory area 208, but also by the user preferences derived from the personalization engine 340.

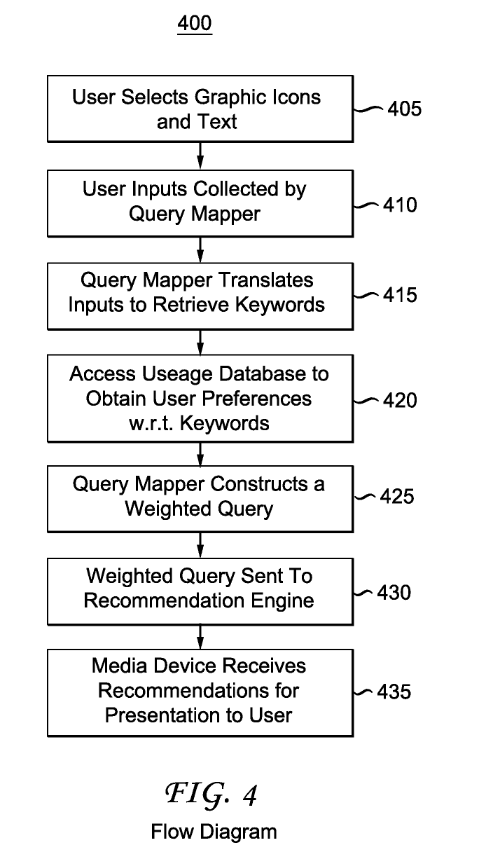

FIG. 4 depicts a flow diagram 400 according to aspects of the invention. This flow 400 represents one typical method using aspects of the invention. At step 405, the user selects a combination of graphic symbols or icons and text as search elements. The graphic icons (symbols) can be selected via any of the windows 202, 203, and/or 204 of example user interface FIG. 2. Icon search elements from all of the windows 202, 203, and 204 can be used or only some of the windows can be used in the construction of a query. The text can be selected via window 201 of example user interface FIG. 2. Also, text may be manually entered via a keyboard. All are part of an organized and ordered sting of search elements that are displayed in factory window 208 of the user interface of FIG. 2. The user organizes the string of elements in the order of most importance to least importance from left to right. There, the first or left-hand most elements are weighted more heavily than the last or right hand most elements in the string of elements that the user collects in factory window 208.

At step 410 the user inputs, in the form of an ordered sting of search elements, are collected by the query mapper 350. In one embodiment, the collection occurs after the user submits the search element string to the query mapper. This can be accomplished, for example, by actuating the build button 205 of FIG. 2. At step 415, the query mapper translates the search elements of the search string to keywords for the purpose of querying the personalization engine 340. In one embodiment, the translation can use a look-up table of search elements versus associated keywords. Also at step 415, the keywords are initially weighted according to their position in the ordered set of search elements. Search elements and their weighted keywords are weighted such that left-hand positioned words are weighted with a higher weight than those further to the right in the string of search elements. This is a positional weighting due to the position of a search element in the set of search elements. At step 420, the personalization engine 340 accesses the usage database 120 to determine if there are any user preferences with respect to the submitted keywords. If there are user preferences, the usage database 120 submits the user preferences back to the query mapper 350 via the personalization engine 340 in order to provide personalized information for use by the query mapper 350. The personalization engine provides some additional weighting information for the translated keywords from the query mapper. In one example, a translated keyword “drama” from a genre window 202 may be scaled for weighting based on the users known history of viewing dramas. If the specific user prefers dramas to other genres, the scaling of the weighting factor may be moved higher to indicate a strong user preference for a drama in the final search. Thus, in a query construction where the icon corresponding to a keyword “drama” is used, it will be weighted according to the position of the keyword in the element string generated by the user in window 208. Also, in addition to the original positional weighting, the personalization engine 340 can provide additional user information which can scale the positional weighting based on a profile of the user. In one embodiment, the personality engine provides scaling factors for each keyword transmitted to the back-end server 118 from the query mapper.

After the query mapper 350 receives a response of personalization information from the personalization engine 340, at step 425 the query mapper has enough information to construct a weighted query for submission to the recommendation engine 330 of the back-end server 118. At step 425, the query mapper receives weighted scaling information from the personalization engine 340 and constructs a final query. At step 430, the fully weighted and constructed final query in the query mapper 350 is submitted to the recommendation engine 330 of the back-end server 118. The recommendation engine 330 receives the full weighted query from the query mapper 350, parses it, and contacts the search indexer and search engine 320 to acquire search results. The search results are then sent to the media device for formatting and presentation to the user at step 435. The user can then select one of the listed items for viewing on a display device. The presentation of search results can be accomplished via either the display unit 114 or via the touch screen device 116. As previously discussed, the results are presented in weighted order as a list displayed to the user on the media device 108.

An example of translation and weighting, the following non-limiting example is provided. An example user input might be:

Tomato icon, drama icon, “Matt Damon” text, “automobiles” text, not spy icon.
After translation and initial search element positional weighting, the keywords may be:
(.5) Highly rated, (.2) Drama, (.2) Matt Damon, (.1) automobiles, no spy genres.
After the personality engine provides user preferences that more heavily rate dramas for the particular user, then the drama element would be scaled upward. The final query may be:
(.4) Highly rated, (.3) Drama, (.2) Matt Damon, (.1) automobiles, no spy genres.
Note that in this example, the total weights add to 1.0. However, any relative scaling can be used as is understood by those of skill in the art. A total weighting scale of 1 to 10, 0 to 5, or an unbounded relative scale may be used. This final query is then sent to the recommendation engine to return search engine results. Also, if no user preferences are found, then the initial positional weighting would be submitted to the recommendation engine.

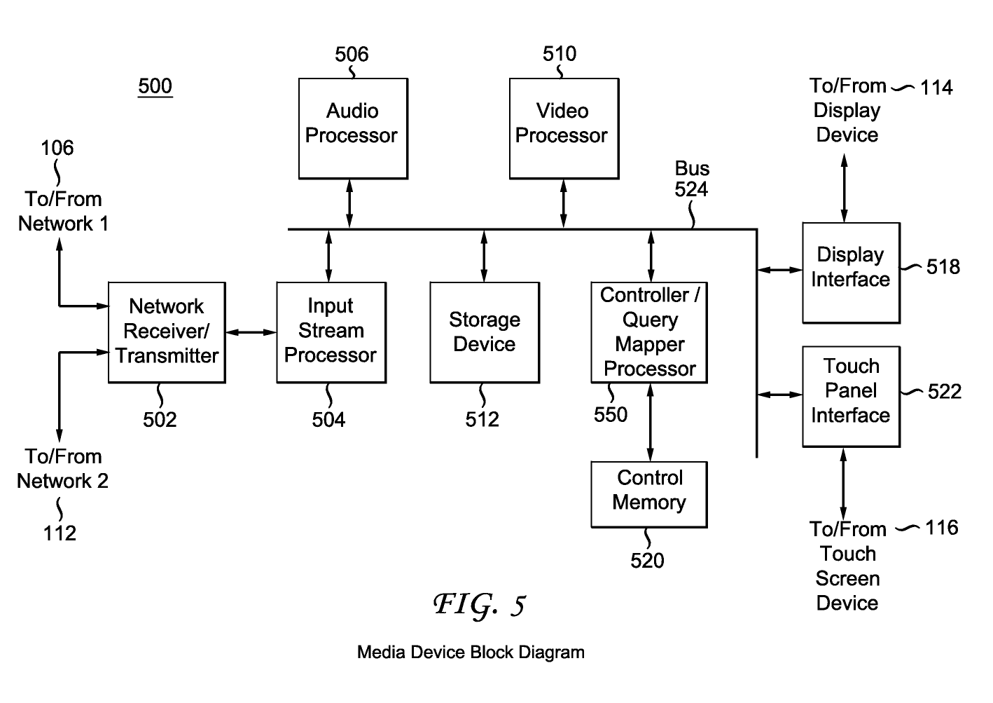

Turning now to FIG. 5, a block diagram of an embodiment of a media device 500 is shown. Media device (also known as a receiving device) 500 can operate similar to the media device 108 described in FIG. 1 and can be included as part of a gateway device, modem, set-top box, computer, or other similar communications device. The media device 500 shown can also be incorporated into other systems including an audio device or a display device. In either case, several components necessary for complete operation of the system are not shown in the interest of conciseness, as they are well known to those skilled in the art. In one exemplary embodiment, media device 500 can be a set top box coupled to a display device (e.g. television). In another embodiment, the media device can be a hand-held (i.e. mobile) or fixed location display device that allows playback of media files.

In the media device 500 shown in FIG. 5, the content is received by a network receiver/transmitter 502. The network receiver/transmitter 502 can be one of several known receiver circuits used for receiving, demodulation, and decoding signals provided over one of the several possible networks including over the air, cable, satellite, Ethernet, fiber and phone line networks. The desired input signal can be selected and retrieved by the network receiver/transmitter 502 based on user input provided through a control interface or touch panel interface 522. Touch panel interface 522 can include an interface for a touch screen device. Touch panel interface 522 can also be adapted to interface to a cellular phone, a tablet, a mouse, a high end remote or the like. In one set of interface embodiments, touch Panel Interface 522 can be a wired or wireless interface. Wireless interfaces can include any over the air interfaces such as an RF interface and a protocol based interface such as IEEE 802.11.

In one embodiment, one or more digital busses 524 interconnect the controller/query mapper processor 550 with other functional blocks. One of skill in the art recognizes that non-bus-oriented topologies are also possible implementations of the media device 500. Blocks that have a bus 524 interface with the processor 550 include input stream processor 504, storage device 512, audio processor 506, video processor 510, display interface 518, and touch panel interface 522.

The decoded output signal of network receiver/transmitter 502 is provided to an input stream processor 504. The input stream processor 504 performs the final signal selection and processing, and includes separation of video content from audio content for the content stream of either network input 106 or 112. The audio content is provided to an audio processor 506 for conversion from the received format, such as compressed digital signal, to an analog waveform signal or equivalent digital audio for use by an output device, such as a display 114 or a touch screen device 116. In one embodiment, a digital audio signal from audio processor 506 can be used to drive a display device using a High-Definition Multimedia Interface (HDMI) cable or alternate audio interface such as via a Sony/Philips Digital Interconnect Format (SPDIF) (not shown). One version of audio interface can also include amplifiers for driving one more sets of speakers. The audio processor 506 also performs any necessary conversion for the storage of the audio signals.

The video output from the input stream processor 504 is provided to a video processor 510 via a bus 524. The video signal can be one of several formats. The video processor 510 provides, as necessary, a conversion of the video content, based on the input signal format. The video processor 510 also performs any necessary conversion for the storage of the video signals.

A storage device 512 stores audio and video content received at the input. The storage device 512 allows later retrieval and playback of the content under the control of a controller 550 and also based on commands, e.g., navigation instructions such as fast-forward (FF) and rewind (RW), received from a user interface (not shown) and/or touch panel interface 522. The storage device 512 can be a hard disk drive, one or more large capacity integrated electronic memories, such as static RAM (SRAM), or dynamic RAM (DRAM), or can be an interchangeable optical disk storage system such as a compact disk (CD) drive or digital video disk (DVD) drive.

The converted video signal, from the video processor 510, either originating from the input or from the storage device 512, is provided to the display interface 518. The display interface 518 further provides the display signal to a display device of the type described above. The display interface 518 can be an analog signal interface such as red-green-blue (RGB) or can be a digital interface such as HDMI.

In one embodiment, the controller 550 hosts the query mapper whose function is to generate a query based on graphic and text user inputs as well as inputs from a personalization engine. The controller 550 also manages the conversion process for converting the input stream signal into a signal for storage on the storage device or for display. The controller 550 also manages the retrieval and playback of stored content.

The controller 550 is further coupled to control memory 520 (e.g., volatile or non- volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 550. Control memory 520 can store instructions for controller 550. Control memory 520 can also store a database of elements, such as graphic elements relating to keywords for the generation of a query based on the search string elements entered by a user. Alternatively, the memory can store the graphic search elements in identified or grouped memory locations and use an access or a location look up table to identify the memory locations for the various portions of information related to the graphic icons or symbols. Further, the implementation of the control memory 520 can include several possible embodiments, such as a single memory device or, alternatively, more than one memory circuit communicatively connected or coupled together to form a shared or common memory. Still further, the memory can be included with other circuitry, such as portions of bus communications circuitry, in a larger circuit.

Optionally, controller 550 can be adapted to extract metadata, criteria, characteristics or the like from audio and video media by using audio processor 506 and video processor 510, respectively. That is, metadata, criteria, characteristics or the like that is contained in the vertical blanking interval, auxiliary data fields associated with video, or in other areas in the video signal can be harvested by using the video processor 510 with controller 550 to generate metadata that can be used for functions such as generating an electronic program guide having descriptive information about received video, supporting an auxiliary information service, and the like. Similarly, the audio processor 506 working with controller 550 can be adapted to recognize audio watermarks that can be in an audio signal. Such audio watermarks can then be used to perform some action such as the recognition of the audio signal, provide security which identifies the source of an audio signal, or perform some other service. Furthermore, metadata, criteria, characteristics or the like, to support the actions listed above can come from a network source which are processed by controller 550.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus, hardware and software apparatus. An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device.

Additionally, the methods may be implemented by instructions being performed by a processor, and such instructions may be stored on a processor or computer-readable media such as, for example, an integrated circuit, a software carrier or other storage device such as, for example, a hard disk, a compact diskette (“CD” or “DVD”), a random access memory (“RAM”), a read-only memory (“ROM”) or any other magnetic, optical, or solid state media. The instructions may form an application program tangibly embodied on a computer-readable medium such as any of the media listed above or known to those of skill in the art.

1. A method of generating a display of media items, the method comprising:
selecting a set of icons and text items representing a set of search elements, the selection displayed on a user interface;
translating the set of search elements into a set of keywords;
determining weightings for keywords in the set of keywords;
generating a weighted query using the set of keywords and the weightings for the keywords;
searching for media items using the weighted query;
receiving media items corresponding to the weighted query; and
displaying a list of media items.

2. The method of claims 1, wherein the set of search elements is an ordered set of search elements.

3. The method of claim 2, wherein determining weightings for keywords comprises determining weightings based on a position of the keywords in the set of keywords.

4. The method of claim 3, wherein determining weightings for each keyword further comprises scaling positional weightings of the keywords based on user preferences associated with the keywords.

5. The method of claim 1, translating the set of search elements into a set of keywords further comprises accessing a look-up table.

6. The method of claim 1, wherein displaying a list of media items comprises displaying a list of media further comprises sorting the list commensurate with the search elements prior to display.

7. An apparatus to generate a search query, the apparatus comprising:
a user interface which accepts a selection of icons and text to form a set of search elements;
a processor which processes the set of search elements to translate the icons and text into keywords, and weights the keywords according to the position of individual search elements in the set of search elements;
a communication interface to acquire user profile information used by the processor to scale the weighted keywords, wherein the processor generates a query using the weighted keywords and the communication interface transmits the query having weighted keywords to a search engine.

8. The apparatus of claim 7, wherein the user interface comprises a display of windows the icons and text selections.

9. The apparatus of claim 8, wherein the display comprises a touch screen device.

10. The apparatus of claim 7, wherein the processor is a query mapper mapping the set of search elements into an ordered set of weighted keywords.

11. The apparatus of claim 7, wherein the communication interface comprises a network receiver/transmitter to acquire user preferences and search engines.

12. The apparatus of claim 7, wherein the apparatus is a media device for generating a query for a media item.
